(19) United States
(12) Patent Application Publication
(10) Pub. No.: US 2024/0055576 A1
(43) Pub. Date: Feb. 15, 2024

(54) ELECTRODES FOR BATTERIES

(71) Applicant: Dyson Technology Limited, Wiltshire (GB)

(72) Inventors: Reza PAKZAD, Swindon (GB); Matthew Robert ROBERTS, Oxford (GB); Steven ROBSON, Bristol (GB); Lesley-Anne WRAY, Gloucester (GB)

(73) Assignee: Dyson Technology Limited, Wiltshire (GB)

(21) Appl. No.: 18/266,570

(22) PCT Filed: Nov. 29, 2021
(86) PCT No.: PCT/GB2021/053104

§ 371 Date: Jun. 9, 2023

(30) Foreign Application Priority Data
Dec. 17, 2020 (GB) 2020027.5

(51) Int. Cl. H01M 4/04

(52) U.S. Cl. CPC H01M 4/0435; H01M 4/0411; H01M 4/0404

(57) ABSTRACT

A method for making an electrode for a battery includes: providing a current collector having a current collector surface; forming an electrode precursor by arranging a plurality of extruded electrode elements on the current collector surface, each electrode element defining an element height above the current collector surface, and neighbouring electrode elements being separated by a spacing; and forming an electrode from the electrode precursor by compressing the electrode elements, thereby reducing the element height of each electrode element and closing the spacing until neighbouring electrode elements meet to form an electrode layer.

### FIELD OF THE INVENTION

This invention relates to methods of making electrodes for batteries, in particular extruded electrodes, and to electrode precursors for making such electrodes.

### BACKGROUND

Traditional batteries featuring a liquid electrolyte typically comprise solid anode and cathode layers with a liquid electrolyte between them. In liquid electrolyte batteries, each anode or cathode layer is usually formed onto a foil by slurry casting, and the foil acts as a current collector for the respective electrode.

Polymer gel batteries are emerging as promising alternatives to these traditional liquid electrolyte batteries. Such battery systems use a polymer gel as the electrolyte and/or electrodes. The polymer gel comprises a gel matrix comprising a polymer and solvent, which has a gel-like consistency: i.e. it is non-fluid, but is also flexible and non-brittle. Different solid powder additives can be impregnated into the gel matrix, so that the gel can act variously as an electrolyte, cathode or anode, depending on the impregnated material.

The various polymer gel constituents (anode, cathode and electrolyte) can be formed by extrusion of the polymer gel. Extrusion is a simple method of manufacturing, which has some benefits over more traditional electrode deposition methods such as slurry casting. However, as the loading of solid powder increases, viscosity of the gel increases, and extrusion becomes more difficult, particularly when extruding objects with very small dimensions. It can also be more difficult to achieve consistent and predictable results with extrusion than with well-known traditional methods such as slurry casting.

It is against this background that the invention has been devised.

### SUMMARY OF INVENTION

According to a first aspect of the invention, there is provided a method for making an electrode for a battery. The method comprises providing a current collector having a current collector surface and forming an electrode precursor by arranging a plurality of extruded electrode elements on the current collector surface. Each electrode element defines an element height above the current collector surface, and neighbouring electrode elements are separated by a spacing. The method further comprises forming an electrode from the electrode precursor by compressing the electrode elements, thereby reducing the element height of each electrode element and closing the spacing until neighbouring electrode elements meet to form an electrode layer. This method provides a convenient two-stage process that enables the production of thinner electrodes than could otherwise be achieved by extrusion. In a first stage, relatively thick electrode elements are arranged on the current collector: being relatively thick the electrode elements can be easily extruded. In a second stage, the electrode elements are compressed and consolidated. During compression their thickness is reduced to form a relatively thin electrode layer that could not easily be obtained by extrusion alone.

The method may further comprise extruding the plurality of extruded electrode elements onto the current collector surface. Extruding the plurality of electrode elements directly onto the current collector surface increases efficiency in the production and handling of the electrodes and can give greater control over the arrangement of electrode elements on the current collector surface.

Each electrode element may be elongate to define a longitudinal axis. In a plane orthogonal to the longitudinal axis, a sum of the cross-sectional areas of the electrode elements may be substantially equal to a sum of the cross-sectional area of the electrode layer. In this way, the cross-sectional area, and hence the volume, of the electrode material, remains constant as the electrode elements are compressed and consolidated into the electrode layer. This enables easy determination of the required size and arrangement of the electrode elements based on a desired thickness of the electrode layer, or vice-versa.

Each electrode element may be of substantially uniform cross section along the longitudinal axis, which may result from the extrusion process. The cross section may preferably define a regular geometric shape, most preferably a circle, oval, oblong or rounded oblong. A uniform cross section and geometric shape allows uniform compression of the electrode elements to produce a uniform electrode layer.

The method may further comprise compressing the electrode precursor using a roller. The roller may define a rotational axis that is orthogonal to the longitudinal axis. A roller is a convenient compression means, and by arranging the roller with its rotational axis orthogonal to the longitudinal axis, a particularly even compression of the electrode elements may be achieved, enabling the production of a particularly uniform electrode layer.

The method may further comprise heating the electrode layer. Where a roller is used, this heating may be achieved by heating the roller such that the roller heats the electrode layer. Heating the electrode layer improves consolidation of the electrode layer where two compressed electrode elements meet, thereby providing a particularly uniform electrode layer. Providing this capability in the roller improves efficiency by combining the heating and pressurising steps.

A centre-to-centre distance between neighbouring electrode elements may be between approximately 0.2 mm and approximately 3 mm. The electrode layer may define a layer height above the current collector surface, which may be between approximately 25 μm and approximately 150 μm. The ratio of the element height to the layer height may be between 4:1 and 20:1. The element height may be between approximately 100 μm and approximately 1000 μm. These dimensions enable a compromise between the ease of extrusion of larger electrode elements and the desire to reduce the extent of compression require to form the electrode layer in order to improve its uniformity.

Each electrode element may comprise a deformable material. The material may be inherently deformable, or the material may have a structure that allows for deformability.

Each electrode element may comprise a polymer electrode material, which may be a solid polymer electrode material or a gel polymer electrode material. Where the polymer electrode material is a gel polymer electrode material, the material may comprise a polymer gel loaded with a solid material that acts as an electrode. Preferably, a solid loading of the polymer gel is between approximately 50% and approximately 80% of the active material. A relatively high loading can decrease extrudability of the electrode material, meaning that a higher element height may be required; by virtue of the invention the higher element height can be reduced by compression to provide a thin electrode layer, despite the high loading.

According to a second aspect of the invention, there is provided an electrode precursor for making an electrode for a battery. The electrode precursor comprises a current collector having a current collector surface and a plurality of extruded electrode elements arranged on the current collector surface. Neighbouring electrode elements are separated by a spacing.

A centre-to-centre distance between neighbouring electrode elements may be between approximately 0.2 mm and approximately 3 mm. The electrode elements may define an element height above the current collector surface, which may be between approximately 100 μm and approximately 1000 μm.

Preferred and/or optional features of one aspect or embodiment may be combined, alone or in appropriate combination, with other features also.

### BRIEF DESCRIPTION OF DRAWINGS

In order that it may be more easily understood, the invention will now be described, by way of example only, with reference to the following drawings in which:

FIGS. 1a and 1b are front and top plan views of an electrode structure in the form of an electrode precursor;

FIGS. 1c and 1d are front and top plan views of an electrode structure in the form of an electrode, which is formed from the electrode precursor of FIGS. 1a and 1b;

FIGS. 2a and 2b are front and top plan views of a current collector presented in a first stage of a method of making the electrode precursor of FIGS. 1a and 1b;

FIGS. 3a and 3b are front and top plan views of a second stage of making the electrode precursor of FIGS. 1a and 1b;

FIGS. 4a and 4b, 5a and 5b and 6a, 6b and 6c illustrate steps in the formation of the electrode of FIG. 1c and 1d, from the electrode precursor of FIGS. 1a and 1b;

FIGS. 7a and 7b are front and top plan views of the electrode made by the process of FIGS. 4a and 4b, 5a and 5b and 6a, 6b and 6c;

FIGS. 8a and 8b are front views illustrating alternative configurations of the electrode precursor shown in FIGS. 1a and 1b.

### DETAILED DESCRIPTION

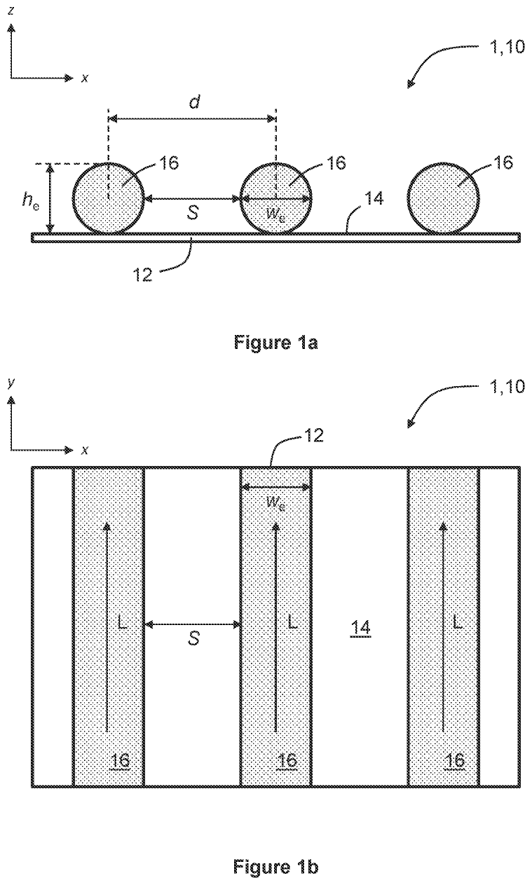

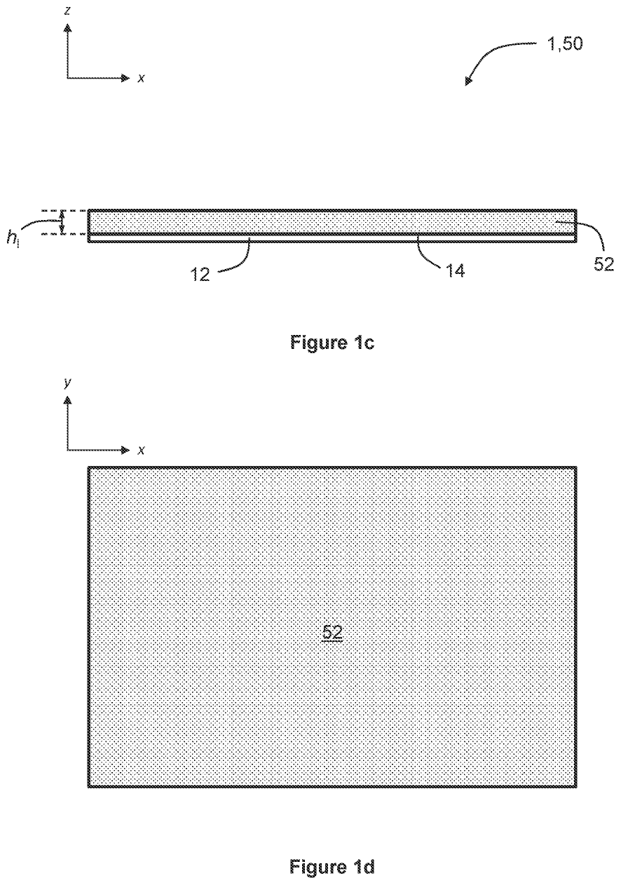

FIGS. 1a and 1b, and FIGS. 1c and 1d illustrate electrode structures 1 comprising a current collector 12 and an electrode material 16, 52. In FIGS. 1a and 1b, the electrode structure 1 takes the form of an electrode precursor 10, and the electrode material takes the form of electrode elements 16, while in FIGS. 1c and 1d, the electrode structure 1 takes the form of an electrode 50, and the electrode material takes the form of an electrode layer 52. The electrode precursor 10 of FIGS. 1a and 1b can be processed to form the electrode 50 of FIGS. 1c and 1d.

Referring to FIGS. 1a and 1b, the electrode precursor 10 comprises a current collector 12, having a current collector surface 14, and a plurality of electrode elements 16 arranged on the current collector surface 14. The electrode elements 16 are elongate in a longitudinal direction (as best shown in FIG. 1b, along the y-direction). Each electrode element 16 has an element height hₑ, defined as the height of the electrode element 16 above the current collector surface 14. Neighbouring electrode elements 16 are separated from each other by a spacing S, which in FIGS. 1a and 1b has a value S₀.

To make the electrode 50 of FIGS. 1c and 1 d from the electrode precursor 10 of FIGS. 1a and 1b, the electrode elements 16 are compressed and consolidated into an electrode layer 52. As the electrode elements 16 are compressed, the element height hₑ of each electrode element 16 is reduced and the spacing S between neighbouring electrode elements 16 is eventually closed. In this way, the electrode 50 produced by compressing the electrode precursor 10 comprises the same current collector 12 and an electrode layer 52 on the current collector surface 14. The electrode layer 52 defines a thickness or layer height hₗ above the current collector surface 14, which is less than the element height hₑ.

The current collector 12 of FIGS. 1a to 1 d is a thin layer of electrically conducting material. The exact material of the current collector 12 will depend on the material of the electrode elements 16 and the electrode layer 52, but the current collector is typically a metal, such as aluminium or copper. The current collector 12 may be provided as a foil and typically has a thickness of between 5 and 20 microns.

The electrode elements 16 of FIGS. 1a and 1b are extruded electrode elements. In this way, the electrode elements 16 and the electrode layer 52 are formed from an extrudable electrode material. The material may be any electrode material that is capable of being deformed so as to reduce its height and increase its width. In this example, the electrode material is a polymer gel electrode material that comprises a polymer gel matrix, impregnated with a solid powder additive.

In other examples, the electrode material may be a solid polymer electrode material, or a ceramic electrode material that is capable of deformation.

The polymer gel matrix comprises a polymer, for example Poly(vinylidene fluoride) (PVdF), and a solvent, for example Poly(ethylene carbonate) EC or Poly(propylene carbonate) PC. The solid power additive may be any material that is capable of accepting or producing the ion species that is to be exchanged in the battery cell. For example, a suitable cathode material may be a lithium-rich nickel manganese cobalt oxide, and a suitable anode material may be graphite or lithium titanium oxide.

The proportion of solid powder that is loaded into the polymer gel matrix affects the viscosity, and hence the extrudability of the electrode: the greater the loading, the higher the viscosity, and hence the less extrudable the electrode material. In this example, solid loadings of up to 80% can be easily accommodated, and the loading is typically between 50% and 80%

The electrode elements 16 extend along the longitudinal axis L along the whole length of the current collector 12. As can be seen in FIG. 1a, the electrode elements 16 have a cross-section in a plane orthogonal to the longitudinal axis L that defines a geometric shape. The shape and dimensions of the cross section are substantially constant along the longitudinal axis L; in the case of FIG. 1a, the electrode elements 16 have a substantially circular cross-section, although other geometric shapes are also envisaged. The shape of the cross section will be defined by the shape of the extrusion die when the electrode element 16 is extruded.

As previously noted, the electrode elements 16 define an element height hₑ above the current collector surface 14. The elements 16 also define an element width wₑ. Both the element height hₑ and element width wₑ may be selected as dimensions that are readily extrudable using an extrusion die head. Since it is generally more difficult to extrude smaller dimensions, it will be appreciated that electrode elements 16 with larger element heights and widths hₑ, wₑ will be generally easier to extrude. Preferably, the element height hₑ and/or element width wₑ is at least approximately 100 μm, for easy extrusion of the electrode element 16. However, it is also desirable to achieve a thin electrode layer 52, and for uniformity of the final electrode layer 52 it can be desirable to reduce the extent of compression required. Therefore the element height hₑ and/or element width wₑ preferably has a maximum thickness of approximately 1000 μm.

The electrode elements 16 are arranged in a regular array across the current collector surface 14, spaced at regular intervals. In this way, a centre-to centre distance d, defined as the distance along the x-direction between the geometric centres of neighbouring electrode elements 16, is the same across each pair of neighbouring electrode elements 16.

As discussed above, the arrangement of the electrode elements 16 defines a spacing S between neighbouring elements. This spacing S is defined as the edge-to-edge spacing, i.e. the minimum distance between the edge of one electrode element 16 and the nearest edge of a neighbouring electrode element 16 along the x-direction. The sum of the spacing S and the element width wₑ is equal to the centre-to-centre distance d, i.e. d=S+wₑ.

The centre-to-centre distance d may be between approximately 0.2 mm and approximately 3 mm, and hence the spacing S may be between approximately 0.1 mm and approximately 2.9 mm.

As the electrode elements 16 are compressed to form the electrode layer 52, the spacing S between neighbouring elements is reduced until the spacing is closed, i.e. until S=0. Thus, in the electrode 50 of FIG. 1b, the electrode layer 52 is formed of one continuous layer of material with no interruptions. In the embodiment shown in FIG. 1b, the layer height hₗ is substantially constant across the electrode 50. The layer height hₗ is preferably between approximately 25 μm and approximately 150 μm.

As noted above, the height hₑ of the electrode elements is greater than a height hₗ of the electrode layer. A ratio of the element height hₑ to the layer height hₗ defines a height reduction ratio hₑ:hₗ. The height reduction ratio may be between 4:1 and 20:1

It will be understood that the height reduction ratio, the element height hₑ, the layer height hₗ, the centre-to-centre distance d and the spacing S are related to each other.

In particular, it will be appreciated that a volume of the electrode material is substantially constant before and after processing of the electrode precursor 10. Thus, in a plane orthogonal to the longitudinal axis L, a total cross-sectional area of all the electrode elements 16 of FIGS. 1a and 1b, must be equal to a cross-sectional area of the electrode layer 52 of FIGS. 1c and 1 d.

A number N of electrode elements 16 with a cross sectional area A, will have a total area of N×A.

If the elements 16 have an initial centre-to-centre distance d between elements, the elements will cover a total width of N×d. When the elements are compressed to form the electrode layer 52, the electrode layer 52 will also cover a total width of N×d. Since the total cross-sectional area of the electrode material must remain constant, a height hₗ of the electrode layer can be calculated as

hₗ=total area/width of layer

hₗ=(N×A)/(N×d)

hₗ=A/d

In the example shown, each electrode element 16 has a circular cross-section with a diameter hₑ, and thus the area A of each element is π×hₑ²/4. In this example, therefore the height hₗ of the electrode layer is related to the height hₑ of the electrode elements with a centre-to-centre distance d by the formula:

hₗ=(π×hₑ²)/(4×d).

It will be appreciated that other corresponding relationships will apply for corresponding shapes.

Thus, when seeking to achieve an electrode layer of a particular layer height or thickness hₗ, electrode elements 16 of appropriate cross-sectional dimensions can be selected, and arranged at appropriate spacings d, to achieve the desired layer height hₗ.

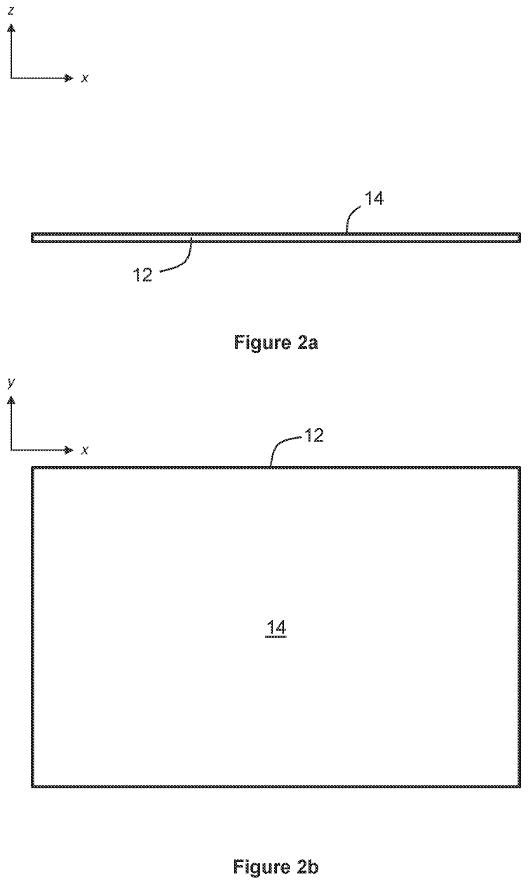

FIGS. 2a to 7b show stages in the method of consolidating the electrode elements 16 of FIGS. 1a and 1b to form the electrode layer 52 of FIGS. 1c and 1d.

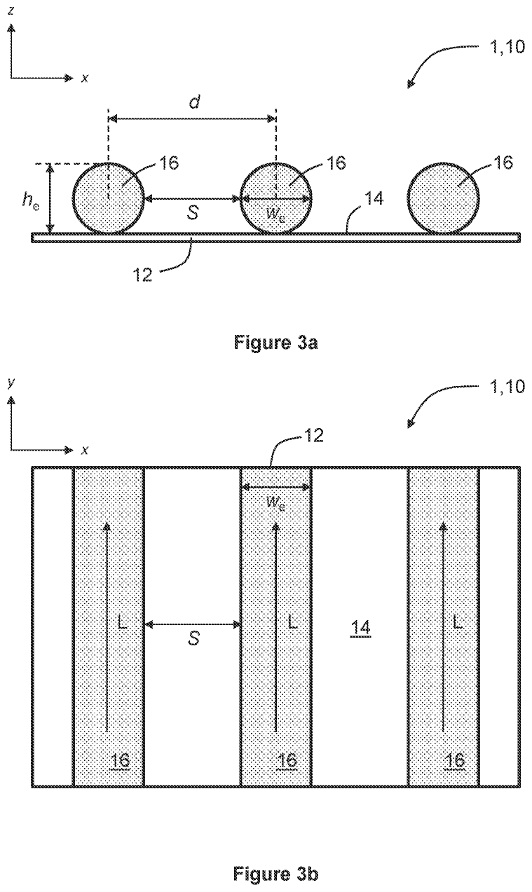

First, the current collector 12 is provided as shown in FIGS. 2a and 2b, with the current collector surface 14 facing upwards. The electrode precursor 10 is then formed, as shown in FIGS. 3a and 3b, by arranging the electrode elements 16 on the current collector surface 14.

As has already been discussed above, the electrode elements 16 are extruded elements. The electrode elements 16 are preferably extruded directly onto the current collector surface 14. Any suitable apparatus may be used for extruding the electrode elements 16, taking into consideration the material requirements for extrusion of polymer gels with high solid loadings. Typically, the electrode material will be extruded through an extrusion opening in a die head, whereby the dimensions of the extrusion opening will determine the dimensions and the cross-sectional area of the electrode elements 16. Each electrode precursor 10 may be extruded individually, or for particularly efficient processing, multiple electrode elements 16, and preferably all the electrode elements 16, may be extruded simultaneously.

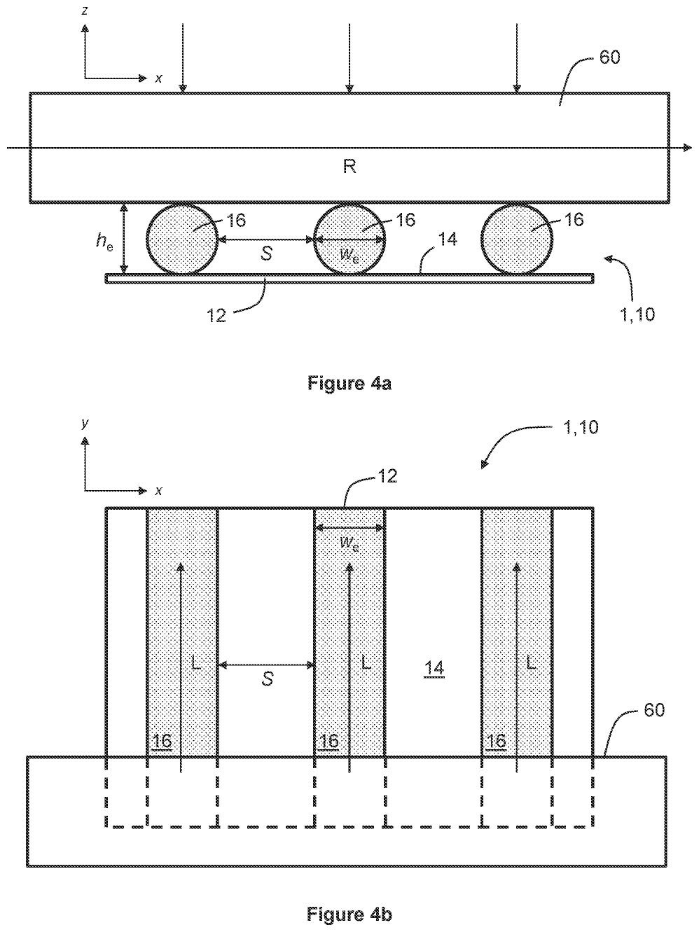

FIGS. 4a and 4b, 5a and 5b and 6a, 6b and 6c show the compression of the electrode elements 16 to form the electrode layer 52.

FIGS. 4a and 4b show the initial application of a compressive force to the electrode elements, which in this example is carried out by a roller 60. The roller 60 defines a rotational axis R that is orthogonal to the longitudinal axis L defined by the electrode elements. The roller 60 is rolled over the electrode elements 16, applying pressure to the electrode elements 16 in a direction orthogonal to the current collector surface 14.

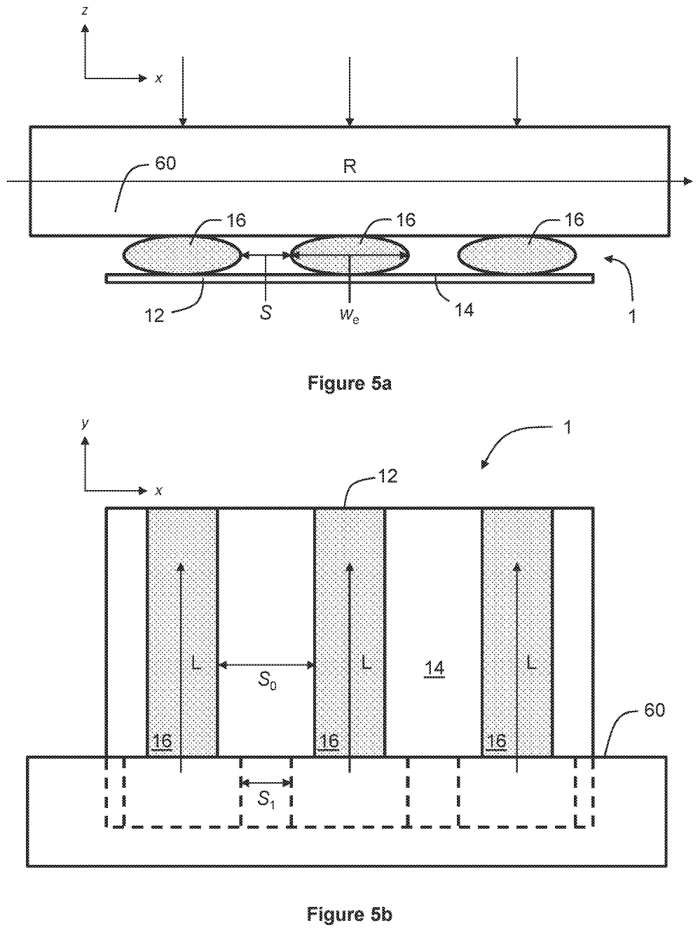

FIGS. 5a and 5b show the electrode elements 16 in a semi-compressed state. In this state, the element height hₑ is reduced and the width wₑ of each electrode element 16 in the x-direction is increased. The spacing between the electrode elements 16 has been reduced from spacing S=S₀ to a smaller spacing S=S₁, as shown in FIG. 5b.

Eventually, where the electrode structure 1 has passed away from the roller 60, the spacing S is closed, or reduced to zero. At this point, the electrode elements 16 have consolidated to form the electrode layer 52.

It will be appreciated that the roller 60 acts on a limited region of the electrode structure 1 as that region passes under the roller 60, and therefore the electrode elements 16 are gradually compressed moving along their longitudinal axes L.

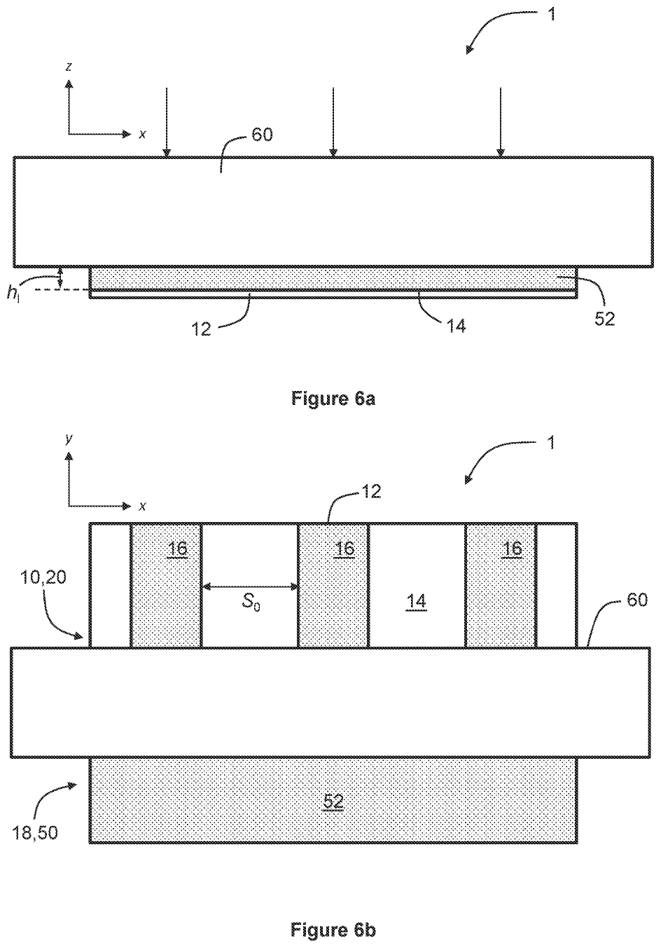

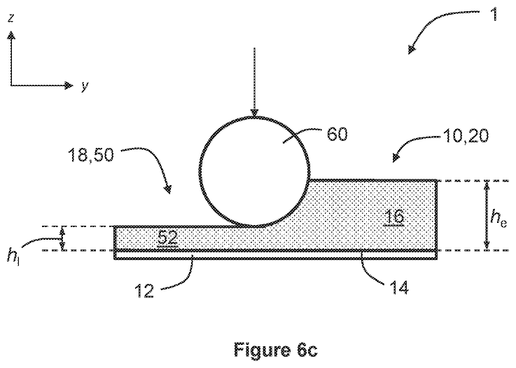

As can be seen in FIGS. 6b and 6c, as the electrode structure 1 passes beneath the roller 60, the electrode elements 16 begin to undergo compression at a first or leading end 10a of the electrode precursor 10, with other trailing areas of each electrode element 16 remaining uncompressed. Relative movement of the second or trailing end 10b towards the roller 60 causes the gradual consolidation of the electrode elements 16 into the compressed electrode layer 52. In this way, a consolidated region 18 of the electrode structure is formed towards the leading end 10a where the electrode structure 1 has already passed the roller 60, and an unconsolidated region 20 remains towards the trailing end 10b where the electrode structure 1 has not yet passed the roller and the electrode elements 16 remain uncompressed.

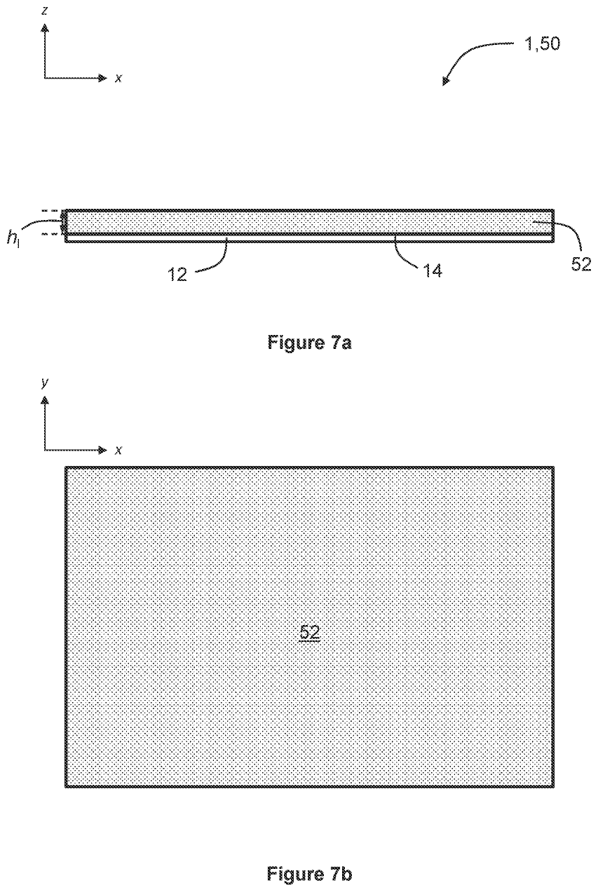

Once the roller 60 has compressed the entire length of the electrode structure 1, the electrode elements 16 have been fully consolidated into the electrode layer 52, the consolidated region 18 covers the entirety of the electrode structure 1, and so the electrode structure 1 takes the form of the electrode 50 across its length, as can be seen in FIGS. 7a and 7b.

The method described allows a thin electrode to be made by extrusion by virtue of a convenient two-stage process. Electrode elements 16 are extruded with relatively large dimensions hₑ, wₑ that can be readily achieved by extrusion. The electrode elements 16 are then compressed and consolidated into an electrode layer of a smaller dimension hₗ that could not be readily achieved by direct extrusion. By extruding the electrode elements that are significantly larger in size than the layer height hₗ, issues surrounding extrusion of gels with high solid loadings are avoided, and a film with more consistent properties can be achieved. Compared to direct extrusion, for a given solid loading, a thinner electrode can be produced or for a given electrode thickness, a higher solid loading can be realised in the gel.

It will be appreciated that in the schematic examples shown, the electrode structure 1 has a relatively short length. However, embodiments are also envisaged in which processing is substantially continuous to form a continuous electrode 50. For example, if the current collector 12 takes the form of a substantially continuous or semi-continuous sheet that may be passed underneath a positionally fixed roller 60 for example using a roll-to-roll construction. In this case, multiple rollers may be used in a calendaring arrangement to apply the required pressure.

In certain embodiments of the invention, a heating step is applied to heat the electrode layer 52. This can improve consolidation by increasing fluidity of the electrode material as it is compressed. Conveniently, this functionality may be incorporated within a heated roller 60, which may apply heating to the electrode material as the electrode elements 16 are compressed. This brings the benefit that no additional steps are required in the method beyond those already present when no heating is applied to the electrode layer 52.

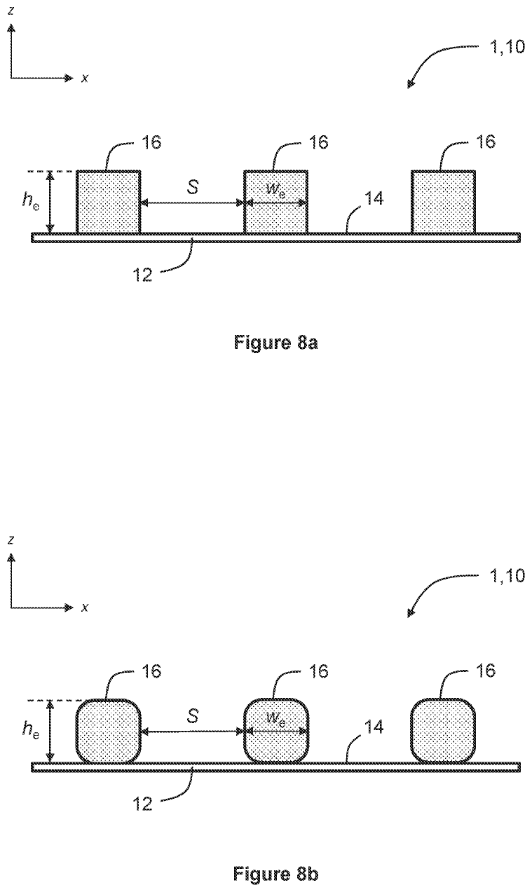

FIGS. 8a and 8b illustrate alternative embodiments of the electrode elements 16, in which the cross-sections of the electrode elements 16 in a plane orthogonal to the longitudinal axis L take shapes different to the circular cross-sections seen in FIGS. 1a and 1b. In FIG. 8a, the electrode elements 16 have a substantially square cross-section, while in FIG. 8b, the electrode elements 16 have a cross-section in the shape of a rounded square. Different cross-sections can be optimised at different solid loadings of the gel that either favour ease of extrusion or the preference of the electrode elements 16 to consolidate into a film when subjected to a compressive force.

It should be appreciated that although the above figures show three electrode elements 16, these figures are merely to illustrate the underlying concept behind the invention and any suitable number of elements may be used. The number N of electrode elements 16 present in the electrode precursor 10 depends on the desired dimensions of the final electrode layer 52, as well as the dimensions and centre-to-centre distance of the electrode elements 16.

Other variations of the inventions will be apparent within the scope of the appended claims.

1. A method for making an electrode for a battery, the method comprising:
providing a current collector having a current collector surface;
forming an electrode precursor by arranging a plurality of extruded electrode elements on the current collector surface, each electrode element defining an element height above the current collector surface, and neighbouring electrode elements being separated by a spacing; and
forming an electrode from the electrode precursor by compressing the electrode elements, thereby reducing the element height of each electrode element and closing the spacing until neighbouring electrode elements meet to form an electrode layer.

2. The method of claim 1, wherein the method comprises extruding the plurality of extruded electrode elements onto the current collector surface.

3. The method of claim 1, wherein each electrode element is elongate to define a longitudinal axis.

4. The method of claim 3, wherein, in a plane orthogonal to the longitudinal axis, a sum of the cross-sectional areas of the plurality of electrode elements is substantially equal to a sum of the cross-sectional area of the electrode layer.

5. The method of claim 3, wherein each electrode element is of substantially uniform cross section along the longitudinal axis.

6. The method of claim 1, comprising compressing the electrode precursor using a roller.

7. The method of claim 6, wherein each electrode element is elongate to define a longitudinal axis and wherein the roller defines a rotational axis that is orthogonal to the longitudinal axis.

8. The method of claim 1, comprising heating the electrode layer.

9. The method of claim 8, comprising compressing the electrode precursor using a roller and heating the roller such that the roller heats the electrode layer.

10. The method of claim 1, wherein a centre-to-centre distance between neighbouring electrode elements is between approximately 0.2 mm and approximately 3 mm.

11. The method of claim 1, wherein the electrode layer defines a layer height above the current collector surface, and wherein the layer height is between approximately 25 μm and approximately 150 μm.

12. The method of claim 1, wherein the electrode layer defines a layer height above the current collector surface, and the ratio of the element height to the layer height is between 4:1 and 20:1.

13-14. (canceled)

15. The method of claim 1, wherein each electrode element comprises a gel polymer electrode material; and wherein the gel polymer electrode material comprises a polymer gel loaded with a solid material that acts as an electrode.

16. An electrode precursor for making an electrode for a battery, the electrode precursor comprising:
a current collector, having a current collector surface; and
a plurality of extruded electrode elements on the current collector surface, neighbouring electrode elements being separated by a spacing.

17. The electrode precursor of claim 16, wherein a centre-to-centre distance between neighbouring electrode elements is between approximately 0.2 mm and approximately 3 mm.

18. The electrode precursor of claim 16, wherein the electrode elements define an element height above the current collector surface, and wherein the element height is between approximately 100 μm and approximately 1000 μm.

19. The electrode precursor of claim 16, wherein each electrode element is elongate to define a longitudinal axis.

20. The electrode precursor of claim 19, wherein, each electrode element is of substantially uniform cross section along the longitudinal axis.

21. The electrode precursor of claim 16, wherein each electrode element comprises a gel polymer electrode material.

22. The electrode precursor of claim 21, wherein the gel polymer electrode material comprises a polymer gel loaded with a solid material that acts as an electrode.
